(19) United States
(12) Patent Application Publication
(10) Pub. No.: US 2026/0008274 A1
(43) Pub. Date: Jan. 8, 2026

(54) PRINTING DEVICE

(71) Applicant: SEIKO EPSON CORPORATION, Tokyo (JP)

(72) Inventor: Hideyuki KATAOKA, MATSUMOTO-SHI (JP)

(21) Appl. No.: 19/258,208

(22) Filed: Jul. 2, 2025

(30) Foreign Application Priority Data
Jul. 5, 2024 (JP) 2024-108727

(51) Int. Cl. B41J 3/46; H04N 1/00

(52) U.S. Cl. CPC B41J 3/46; H04N 1/00129

(57) ABSTRACT

A printing device 1 includes a printing section 5 for printing on a medium M, a housing 100 for covering at least a first direction of the printing section 5, and a display panel 300. The display panel 300 is displaceable between a stored position in which a display screen 305 is stored in the housing 100 so as to face a first direction and an exposed position in which the display screen is exposed to the outside from the housing 100 so as to be visible when viewed from a second direction, which intersects the first direction. The display panel 300 has a display light 302 that, in the exposed position, is visible when viewed from a third direction, which is the opposite from the second direction, and the display light 302 is variable in illumination state.

The present application is based on, and claims priority from JP Application Serial Number 2024-108727, filed Jul. 5, 2024, the disclosure of which is hereby incorporated by reference herein in its entirety.

### BACKGROUND

### 1. Technical Field

The present disclosure relates to a printing device.

### 2. Related Art

In the related art, various printing devices are used. Among these, there is a printing device including a display panel in a housing. For example, JP-A-2021-51130 discloses a printer including an operation panel having a display section in a housing, and the operation panel can be pivoted about a pivot shaft.

In the printer of JP-A-2021-51130, the exposed surface of the operation panel including the display section is provided to be flush with the exterior surface of the housing that houses the operation panel, and the operation panel is exposed to the outside from the upper surface of the housing by pivoting the operation panel with respect to the pivot shaft. In the printing device including the display panel in the housing of the related art such as the printer of JP-A-2021-51130, since the display screen faces the front side when the display panel is exposed from the housing, the display information of the display panel can be confirmed from the front side, but the display information of the display panel cannot be confirmed from the back surface side.

### SUMMARY

To overcome the above problem, the printing device of the present disclosure includes a printing section configured to print on a medium; a housing that covers at least a first direction of the printing section; and a display panel configured to be displaced to a stored position in which a display screen faces a first direction and is stored in the housing and to an exposed position in which the display panel is exposed from the housing to outside so that the display screen is visible when viewed from a second direction that intersects the first direction, wherein the display panel includes a display light that, in the exposed position, is visible when viewed from a third direction that is opposite to the second direction and an illumination state of the display light is variable.

### BRIEF DESCRIPTION OF THE DRAWINGS

FIG. 1 is a schematic side surface view of a printing device according to a first embodiment of the present disclosure, illustrating a state in which a display panel is disposed in an exposed position.

FIG. 2 is a perspective view showing the periphery of the display panel of the printing device of FIG. 1, and is a view showing a state where the display panel is arranged in a stored position.

FIG. 3 is a perspective view showing the periphery of the display panel of the printing device of FIG. 1, and is a view showing a state where the display panel is arranged in the exposed position.

FIG. 4 is a perspective view illustrating the periphery of a display panel of a printing device according to a second embodiment of the present disclosure, and illustrates a state in which the display panel is disposed in a stored position.

FIG. 5 is a perspective view showing the periphery of the display panel of the printing device of FIG. 4, and is a view showing a state where the display panel is arranged in an exposed position.

FIG. 6 is a perspective view illustrating the periphery of a display panel of a printing device according to a third embodiment of the present disclosure, and illustrates a state in which the display panel is disposed in a stored position.

FIG. 7 is a perspective view illustrating the periphery of a display panel of a printing device according to a fourth embodiment of the present disclosure, and illustrates a state in which the display panel is disposed in a stored position.

FIG. 8 is a perspective view illustrating the periphery of a display panel of a printing device according to a fifth embodiment of the present disclosure, and illustrates a state in which the display panel is disposed in a stored position.

FIG. 9 is a perspective view illustrating the periphery of a display panel of a printing device according to a sixth embodiment of the present disclosure, and illustrates a state in which the display panel is disposed in an exposed position.

### DESCRIPTION OF EMBODIMENTS

First, the present disclosure will be schematically described.

A printing device according to a first aspect of the present disclosure for overcoming the above problem includes a printing section configured to print on a medium; a housing that covers at least a first direction of the printing section; and a display panel configured to be displaced to a stored position in which a display screen faces a first direction and is stored in the housing and to an exposed position in which the display panel is exposed from the housing to outside so that the display screen is visible when viewed from a second direction that intersects the first direction, wherein the display panel includes a display light that, in the exposed position, is visible when viewed from a third direction that is opposite to the second direction and an illumination state of the display light is variable.

According to this aspect, the display panel includes the display light, which is visible in the exposed position when viewed from the third direction, and the illumination state of the display light is variable. With such a configuration, the display light provided in the display panel can be seen from the side opposite from the display screen of the display panel when the display panel is exposed. In addition, since the illumination state of the display light is variable, it is possible to check various kinds of information from the back surface side when the display panel is exposed from the housing.

A printing device according to a second aspect of the present disclosure is an aspect according to the first aspect, in which the display light is provided at a position which, in the exposed position, is an end section of the display panel in the first direction when viewed from the second direction.

According to this aspect, the display light is provided at a position which, in the exposed position, is an end section of the display panel in the first direction when viewed from the second direction. With such a configuration, when the display panel is exposed, the display light provided on the display panel can be particularly easily seen from the third direction, which is substantially opposite to the direction in which the display screen of the display panel faces.

A printing device according to a third aspect of the present disclosure is an aspect according to the second aspect, wherein the display light is provided on a protruding section that, in the exposed position, protrudes in the first direction when viewed from the second direction.

According to this aspect, the display light is provided on the protruding section that, in the exposed position, protrudes in the first direction when viewed from the second direction. With such a configuration, when the display panel is exposed, the display light provided on the display panel can be particularly easily seen from the third direction, which is substantially opposite to the direction in which the display screen of the display panel faces.

A printing device according to a fourth aspect of the present disclosure is an aspect according to the third aspect, in which the protruding section is stored in the display panel in the stored position and, in conjunction with displacement from the stored position to the exposed position, protrudes in the first direction when viewed from the second direction.

According to this aspect, the protruding section is stored in the display panel in the stored position and, in conjunction with the displacement from the stored position to the exposed position, protrudes in the first direction when viewed from the second direction. With such a configuration, the storage volume of the display panel can be reduced, and an increase in the size of the device can be suppressed.

A printing device according to a fifth aspect of the present disclosure is an aspect according to the second aspect, wherein the display light is provided across an entire widthwise direction in a position that, in the exposed position, is an end section of the display panel in the first direction when viewed from the second direction.

According to this aspect, the display light is provided over the entire widthwise direction of the position that, in the exposed position, becomes the first direction end section of the display panel when viewed from the second direction. With such a configuration, when the display panel is exposed, the display light provided on the display panel can be particularly easily seen from the third direction, which is substantially opposite to the direction in which the display screen of the display panel faces.

A printing device according to a sixth aspect of the present disclosure is an aspect according to the first aspect, wherein the display light is provided so as to be visible from a side facing a back surface, which is opposite from the display screen.

According to this aspect, the display light is provided so as to be visible from the side facing the back surface, which is opposite from the display screen. With such a configuration, when the display panel is exposed, the display light provided on the display panel can be easily seen from the third direction, which is substantially opposite from the direction in which the display screen of the display panel faces, and is the back surface side of the apparatus.

A printing device according to a seventh aspect of the present disclosure is an aspect according to the sixth aspect, wherein the display light protrudes from the back surface in the exposed position.

According to this aspect, the display light protrudes from the back surface in the exposed position. With such a configuration, when the display panel is exposed, the display light provided on the display panel can be easily seen from the third direction, which is substantially opposite from the direction in which the display screen of the display panel faces, and is the back surface side of the apparatus, and can also be easily seen from the side surface side.

A printing device according to an eighth aspect of the present disclosure is an aspect according to the sixth aspect, wherein the display light is provided on a side surface in a direction that intersects the display screen and the back surface.

According to this aspect, the display light is provided on the side surface in the direction intersecting the display screen and the back surface. With such a configuration, when the display panel is exposed, the display light provided on the display panel can be easily seen from the third direction, which is substantially opposite from the direction in which the display screen of the display panel faces, and is the back surface side of the apparatus, and can also be easily seen from the side surface side.

A printing device according to a ninth aspect of the present disclosure is an aspect according to the sixth aspect, wherein the display light is provided so as to be visible from a side facing the display screen and the back surface has a translucent section through which light is transmitted toward a side facing the back surface.

According to this aspect, the display light is provided so as to be visible from the side facing the display screen, and the back surface includes a translucent section through which light is transmitted toward the side facing the back surface. With such a configuration, when the display panel is exposed, various pieces of information displayed on the display screen can be checked from the third direction, which is substantially opposite from the direction in which the display screen of the display panel faces, and which is the back surface side of the apparatus.

### FIRST EMBODIMENT

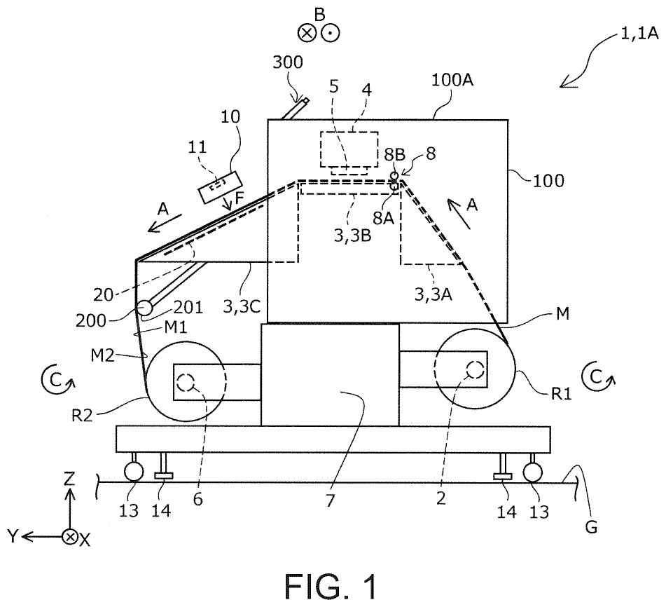

Hereinafter, embodiments according to the present disclosure will be described in detail with reference to the drawings. First, an overview of a printing device 1A according to a first embodiment, which is an example of printing device 1 of the present disclosure, will be described with reference to FIG. 1. In FIG. 1, some components are simplified and omitted for easy understanding of the configuration. Here, in each of the drawings, an X-axis direction is a horizontal direction that is an axial direction of a roll body R1 in which the medium M is wound into a roll shape, a Y-axis direction is a horizontal direction that is a front-rear direction of the printing device 1A and that is a direction orthogonal to the X-axis direction, and a Z-axis direction is the vertical direction. Hereinafter, a direction indicated by an arrow is referred to as a + direction, and a direction opposite to the direction indicated by the arrow is referred to as a − direction. For example, a vertically upward direction is a +Z direction, a vertically downward direction is a −Z direction, a front surface direction of the printing device 1A is a +Y direction, and a back surface direction of the printing device 1A is a −Y direction.

As illustrated in FIG. 1, the printing device 1A of the present embodiment includes a housing 100, and a leg frame 7 is attached to portions near both X-axis direction ends of the housing 100. Casters 13 and adjusters 14 are provided below the leg frame 7. The printing device 1A can be easily moved by using the casters 13, and the printing device 1A can be suitably installed on an installation surface G by using the adjusters 14. The printing device 1A of the present embodiment includes a supply section 2 that is on the-Y direction side, which is the rear side of the housing 100, and that holds the roll body R1. The supply section 2 supports a paper tube of the roll body R1, around which the medium M is wound, so as to sandwich the paper tube in the X-axis direction, and supplies the medium M to a position facing a head 5, which functions as a printing section.

A display panel 300 is provided on the upper surface 100A, which is the surface on the +Z direction side of the housing 100. Details of the display panel 300, which is a main component of the printing device 1A according to the present embodiment, will be described later. The upper surface 100A is a flat surface extending in the X-axis direction and the Y-axis direction. In a state where the printing device 1A is installed on the installation surface G, the upper surface 100A is preferably horizontal. The upper surface 100A can be used by the user as a work area. The user can use the upper surface 100A instead of a workbench. For example, the user can operate information terminals and check printed materials on the upper surface 100A. The height of the upper surface 100A from the installation surface G in the vertical direction (Z direction) may be configured to take into account the workability for the user.

In the printing device 1A according to the present embodiment, when the medium M is to be transported in the transport direction A, the supply section 2 rotates the roll body R1 in the rotation direction C. In FIG. 1, a roll body R1 is used that is wound so that the image forming surface M1 on which an image is formed is on the outer side, but in the case of using a roll body R1 wound so that the image forming surface M1 is on the inner side, the supply section 2 can feed the medium M by rotating the roll body R1 in the direction opposite to the rotation direction C.

The printing device 1A of the present embodiment includes a transport path of the medium M formed by a medium support section 3 that supports the medium M on a support surface. As the medium support section 3, the printing device 1A includes, from the upstream side to the downstream side in the transport direction A, an upstream side medium support section 3A, a platen 3B, and a downstream side medium support section 3C.

In the transport path, the printing device 1A includes a roller pair 8 including a drive roller 8A and a driven roller 8B as a transport section for transporting the medium M in the transport direction A. However, the configuration of the transport section is not particularly limited.

The printing device 1A of the present embodiment includes a head 5, as a printing section, that is provided with a plurality of nozzles at a position facing the platen 3B and that forms an image by ejecting ink, which is liquid, from the nozzles, and a carriage 4 on which is mounted the head 5 and that can reciprocate in the widthwise direction B. That is, the widthwise direction B corresponds to the scanning direction of carriage 4. A liquid supply path (not shown) formed of a tube or the like is connected to the head 5, and ink is supplied from an ink cartridge (not shown) to the head 5 through the liquid supply path. In the printing device 1A according to the present embodiment, the transport direction A at a position on the platen 3B facing the head 5 is the +Y direction, the movement direction of the head 5, that is, the widthwise direction B, which is the scanning direction of the carriage 4, is a direction along the X-axis direction, and the ink discharge direction is the −Z direction.

With the above-described configuration, the head 5 can form an image by ejecting ink from nozzles (not shown) onto the transported medium M, while reciprocating in the widthwise direction B, which is a direction that intersects the transport direction A. The printing device 1A according to the present embodiment can form a desired image on the medium M by repeating the process of transporting the medium M in the transport direction A by a predetermined transport amount and, while the medium M is stopped, ejecting ink while moving the head 5 in the widthwise direction B. However, such a configuration is not a limitation, and a configuration including a so-called line head in which nozzles ejecting ink along the widthwise direction B are arranged over the entire width of the medium M, a configuration including a thermal transfer type printing section, or the like may be adopted.

A heater 20 is provided in the downstream side medium support section 3C of the medium support section 3 as a heating section for heating the supported surface M2, which is at the opposite side of the medium M from the image forming surface M1. In the present embodiment, the heater 20 is composed of an electric heating wire or the like, but is not limited to such a configuration. A medium heating section that heats the supported surface M2 on the opposite side of the medium M from the image forming surface M1 may be provided not only in the downstream side medium support section 3C, but also in the upstream side medium support section 3A and in the platen 3B.

A blower section 10 that dries the ink ejected from head 5 onto the image forming surface M1 of the medium M by blowing an air current F is provided in a portion of the transport path facing the downstream side medium support section 3C. The blower section 10 of the present embodiment includes a fan 11 that generates the air current F, and is configured to be capable of blowing gas to the image forming surface M1 of the medium M as the air current F, but such a configuration is not a limitation.

A winding section 6 that winds the medium M that was transported in the transport direction A into a roll shape to form a roll body R2 is provided downstream of the downstream side medium support section 3C in the transport direction A. Note that in the printing device 1A according to the present embodiment, the supply section 2 and the winding section 6 have the same configuration. The medium M transported from the supply section 2 to the winding section 6 is transported in a state in which a predetermined tension is applied by the winding section 6 or the like. The winding section 6 supports a paper tube, which is the winding core of the roll body R2, so as to sandwich the paper tube in the X-axis direction, and winds the medium M into a roll shape by rotating the paper tube. In FIG. 1, the winding section 6 rotates the roll body R2 in the rotation direction C so that the image forming surface M1 is wound with the image forming surface M1 facing outward, but it may wind up the medium M so that the image forming surface M1 faces inward. In this case, the winding section 6 rotates the roll body R2 in the direction opposite to the rotation direction C.

Note that a guide bar 200 is provided between the downstream side medium support section 3C and the winding section 6 in the transport direction A. The guide bar 200 has a circular-arc shaped contact surface 201 when viewed from the widthwise direction B. The guide bar 200 guides the transport of the medium M by the contact surface 201 contacting the supported surface M2 of the medium M being wound up by the winding section 6. However, the configuration of the guide bar 200 is not particularly limited, and furthermore, it may be configured without the guide bar 200.

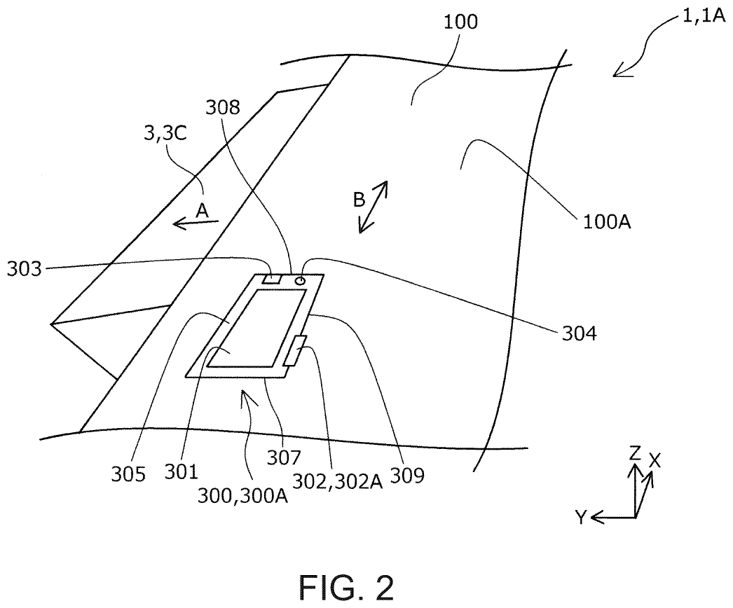

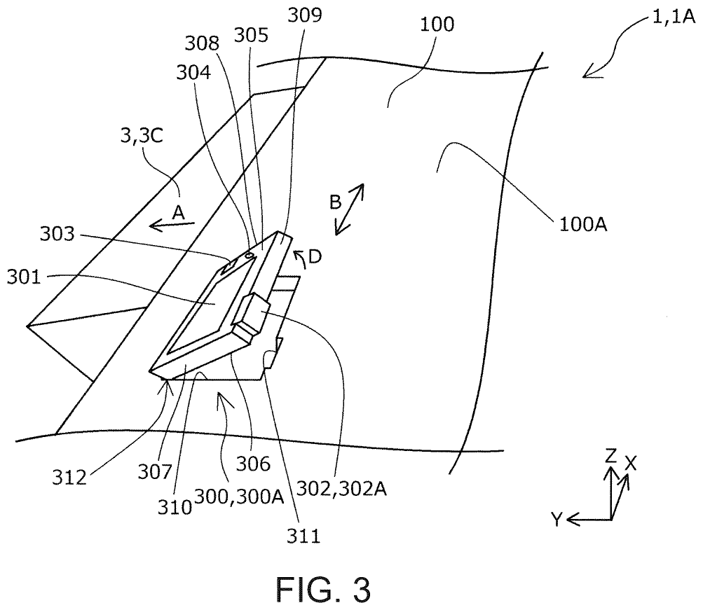

As described above, the printing device 1A according to the present embodiment includes the head 5 as a printing section that performs printing on the medium M, the housing 100, and the display panel 300 provided on the upper surface 100A of the housing 100. Here, as shown in FIG. 1, the housing 100 covers the +Z direction side, which is the upper side, of the head 5, in other words, at least a first direction of the head 5. Hereinafter, details of the display panel 300A of the printing device 1A according to the present embodiment as an example of the display panel 300 will be described with reference to FIGS. 2 and 3.

The display panel 300A of the present embodiment includes a screen 301, an instruction button 303, a power button 304, and a pivot shaft 312 that extends along the X-axis direction. By pivoting in the direction D about the pivot shaft 312, a display screen 305 can be displaced between a stored position in which, as shown in FIG. 2, the display screen 305 faces the +Z direction, which is the first direction, and is housed within the housing 100, and an exposed position in which, as shown in FIG. 3, the display screen 305 is exposed outside the housing 100 and is visible from a second direction (+Y direction), which intersects the first direction (+Z direction). Note that the state shown in FIG. 3 is a state in which the display panel 300A is pivoted by about 45° with respect to the upper surface 100A.

However, the display panel 300A can be pivoted by 90 degrees or more with respect to upper surface 100A. Therefore, in the state in which the display panel 300 is in the exposed position shown in FIG. 3, the direction in which the display screen 305 of the display panel 300A faces is a direction having a vector component in the +Z direction and a vector component in the +Y direction, but the direction in which the display screen 305 faces when the display panel 300 is in the exposed position is not limited to such a direction. For example, the direction in which the display screen 305 faces may be the +Y direction when the display panel 300 is pivoted by 90°, or the direction in which the display screen 305 faces may be a direction with a vector component in the −Z direction and a vector component in the +Y direction when the display panel 300 is pivoted by more than 90°. That is, any direction in which the display screen 305 faces is acceptable as long as it has a vector component in the +Y direction.

As shown in FIGS. 2 and 3, the display panel 300A includes a display light 302 that, in the exposed position shown in FIG. 3, is visible when viewed from the −Y direction, which is the back surface side, in other words, a third direction opposite to the second direction. Here, a display light 302A of the printing device 1A in the present embodiment as display light 302 is configured by a light emitting diode (LED) or the like, but is not limited to such a configuration. The illumination state of the display light 302A of the present embodiment is variable.

In this way, the display panel 300A according to the present embodiment includes the display light 302A that in the exposed position is visible when viewed from the third direction, and the illumination state of the display light 302A is variable. With such a configuration, when the display panel 300A is exposed, the display light 302A provided on the display panel 300A is visible from the back surface 306, which is the side of the display panel 300A opposite from the display screen 305. Since the illumination state of the display light 302A is variable, the user can check various kinds of information, such as the occurrence of an error, based on the illumination state of the display light 302A, also from the third direction (−Y direction) side, which is the back surface side when the display panel 300A is exposed from the housing 100.

That is, even in a state in which the screen 301 of the display panel 300A is difficult to see, the user can obtain various types of information by checking the illumination state of the display light 302A. The various types of information indicated by the display light 302A may include information other than that related to the printing device 1A. Since the printing device 1A of the present embodiment is provided with the supply section 2 that holds the roll body R1 on the −Y direction side, which is the rear side of the housing 100, the user sometimes works at the rear side of printing device 1A when replenishing or replacing roll body R1. In a case where the user works at the rear side of the printing device 1A, there is a possibility that it is difficult for the user to see the display screen 305, but it is possible for the user to obtain various types of information from the display light 302A.

If the printing device 1A is set at a height at which the user can use the upper surface 100A as a work area, there is a possibility that the display light 302A of the display panel 300A provided on the upper surface 100A can be seen from a place remote from the printing device 1A. In some cases, it is difficult for the user to see the display screen 305 from a place distant from the printing device 1A. However, since there is a possibility that the user can see the illumination state of the display light 302A, there is a possibility that the user can obtain various types of information by checking the display light 302A.

Note that the method of changing the illumination state is not particularly limited, and various methods such as changing the lighting color, changing the lighting intensity, and changing the lighting pattern such as a blinking pattern can be used. The configuration of the display light 302A is also not particularly limited, and various configurations can be used, such as a light emitting body itself such as an electric bulb or an LED, or a member capable of transmitting or refracting light from the light emitting body and irradiating the light outward.

As shown in FIGS. 2 and 3, the display light 302A of the present embodiment is provided at an end section of a pivoting end surface 309 of the display panel 300A, in other words, at a position which is an end section of the display panel 300A in the first direction (+Z direction) when viewed from the second direction (+Y direction) in the exposed position shown in FIG. 3. With such a configuration, when the display panel 300A is exposed, the display light 302A provided on the display panel 300A can be particularly easily seen from the back surface 306 side, which is the side of the display panel 300A that is opposite from the display screen 305, that is, from the third direction (−Y direction) side, which is the back surface side of the printing device 1A of the present embodiment.

As shown in FIGS. 2 and 3, in the printing device 1A of the present embodiment, the display light 302A is configured to protrude from the pivoting end surface 309. In other words, the display light 302A of the present embodiment is provided in a protruding section that protrudes in the first direction (+Z direction) as viewed from the second direction (+Y direction) in the exposed position shown in FIG. 3. With such a configuration, when the display panel 300A is exposed, the display light 302A provided on the display panel 300A can be particularly easily seen from the back surface 306 side, which is the side of the display panel 300A opposite from the display screen 305, that is, from the −Y direction side, which is the back surface side of the printing device 1A of the present embodiment. Since in the exposed position the display light 302A protrudes in the first direction (+Z direction) from the pivoting end surface 309, the display light SL can be seen even when viewed from the widthwise direction B (X direction).

Describing the display light 302A of the present embodiment from another point of view, the display light 302A is provided so as to be visible from a side facing the back surface 306, which is the side opposite from the display screen 305. With such a configuration, it is possible to make it easy to see the display light 302A provided on the display panel 300A from the third direction (−Y direction) side, which is the side of the display panel 300A substantially opposite from the display screen 305 and which is the back surface side of the printing device 1A of the present embodiment.

### SECOND EMBODIMENT

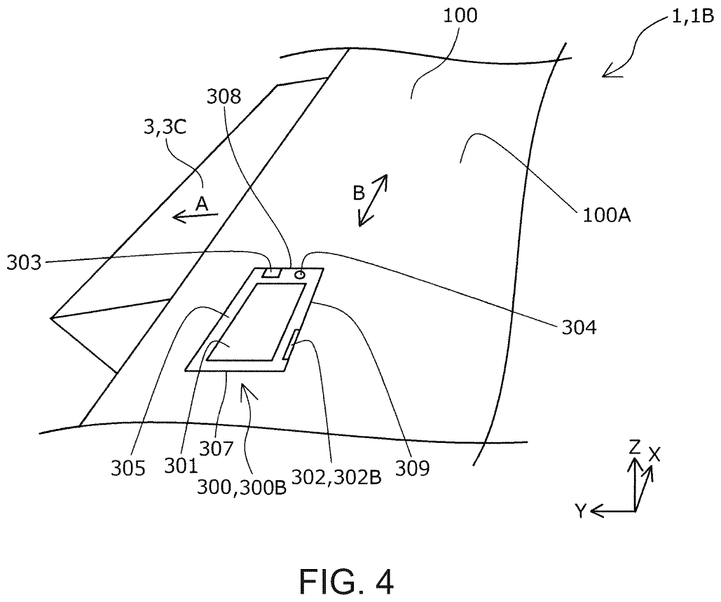

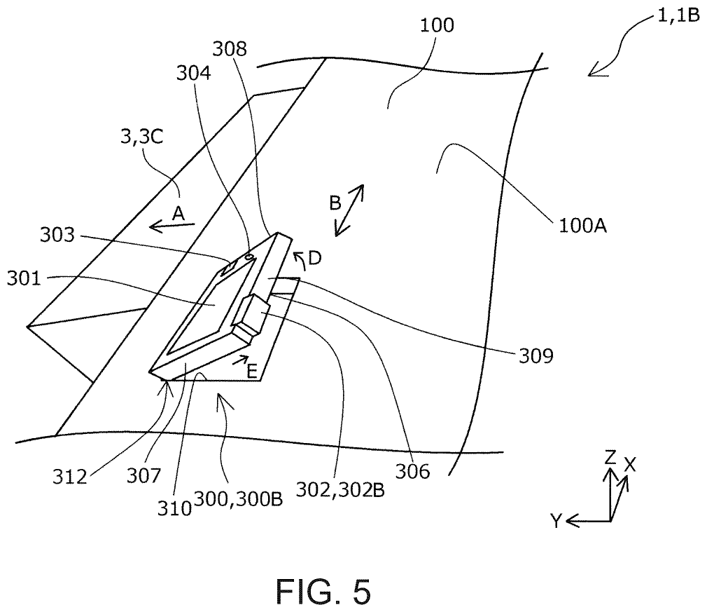

Next, a printing device 1B according to a second embodiment will be described with reference to FIGS. 4 and 5. In FIGS. 4 and 5, components common to those of the first embodiment are denoted by the same reference numerals, and detailed description thereof will be omitted. FIG. 4 is a diagram corresponding to FIG. 2 in the printing device 1A of the first embodiment, and FIG. 5 is a diagram corresponding to FIG. 3 in the printing device 1A of the first embodiment. The printing device 1B according to the present embodiment has the same configuration as the printing device 1A according to the first embodiment, except for the configurations of the display panel 300B and the accommodation section 310 for the display panel 300B. For this reason, the printing device 1B of the present embodiment has the same features as those of printing device 1A of the first embodiment, except for the portions described below.

As described above, in the printing device 1A according to the first embodiment, the display light 302A, which is a protruding section, is provided on the pivoting end surface 309 of the display panel 300A. However, the display light 302A is configured to be immovable with respect to the display panel 300A. Therefore, in the printing device 1A of the first embodiment, as shown in FIG. 3, a recess section 311 corresponding to the display light 302A is provided in the accommodation section 310. The display light 302A protruding from the display panel 300A is housed in the recess section 311.

On the other hand, in the printing device 1B of the present embodiment, the display light 302B, which is a protruding section, is housed in the display panel 300B in the stored position shown in FIG. 4 and, as shown in FIG. 5, protrudes out from the display panel 300B in the protruding direction E in conjunction with displacement from the stored position to the exposed position, in other words, is configured to protrude in the first direction (+Z direction) as viewed from the second direction (+Y direction). Since the printing device 1B of the present embodiment has such a configuration, it is possible to reduce the storage volume of the display panel 300B in the accommodation section 310, and it is possible to suppress an increase in the size of the device. The configuration of the accommodation section 310 is also simple and has a good appearance since the recess section 311 corresponding to the display light 302A of the printing device 1A according to the first embodiment is not provided.

It should be noted that any configuration can be used as long as the display light 302B is stored in the display panel 300B in the stored position. For example, the pop-out amount of the display light 302B may change according to the angle of the display panel 300B pivoted around the pivot shaft 312, or the display light 302B may pop out all at once when the display panel 300B is displaced from the stored position to the exposed position. In the case of a configuration in which the display light 302B pops out all at once when the display panel 300B is displaced from the stored position to the exposed position, it may be configured such that the display light 302B pushed by the edge of the accommodation section 310 or the like in conjunction with the display panel 300B being stored in the stored position may be pushed into and stored in the display panel 300B.

### THIRD EMBODIMENT

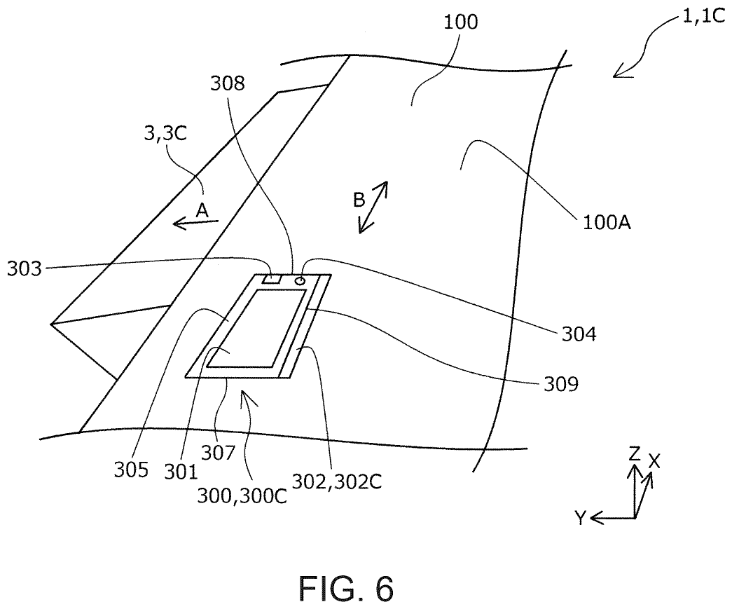

Next, a printing device 1C according to a third embodiment will be described with reference to FIG. 6. In FIG. 6, components common to those of the first embodiment and the second embodiment are denoted by the same reference numerals, and detailed description thereof will be omitted. FIG. 6 is a diagram corresponding to FIG. 2 in the printing device 1A according to the first embodiment. The printing device 1C according to the present embodiment has the same configuration as the printing device 1A according to the first embodiment, except for the configurations of the display panel 300C and the accommodation section 310 for the display panel 300C. For this reason, the printing device 1C of the present embodiment has the same features as those of the printing device 1A of the first embodiment, except for the portions described below.

As illustrated in FIGS. 2 and 3, in the printing device 1A according to the first embodiment, the display light 302A is provided only on a portion in the widthwise direction B (the portion on the-X direction side) of the pivoting end surface 309 of the display panel 300A. On the other hand, as illustrated in FIG. 6, in the printing device 1C of the present embodiment, the display light 302C is provided over the entire widthwise direction B of the pivoting end surface 309, which is a position that is an end section in the first direction (+Z direction) of the display panel 300C as viewed from the second direction (+Y direction) in the exposed position. Since the printing device 1C of the present embodiment has such a configuration, when the display panel 300C is exposed, the display light 302C provided on the display panel 300C can be particularly easily seen from the third direction (−Y direction), which is the side of the display panel 300C substantially opposite from the display screen 305. Note that the display light 302C of the present embodiment has the same configuration as the display light 302A of the printing device 1A of the first embodiment, except that the display light SL is provided over the entire widthwise direction B. Therefore, in the exposed position, the display light 302C is positioned in the first direction (+Z direction) with respect to the pivoting end surface 309, even when viewed from the widthwise direction B (X direction), and can be seen also from the widthwise direction B (X direction).

### FOURTH EMBODIMENT

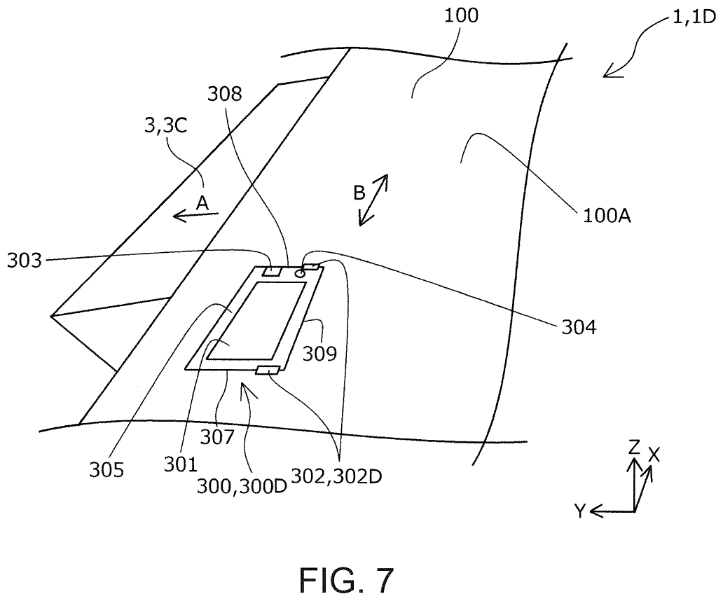

Next, a printing device 1D according to a fourth embodiment will be described with reference to FIG. 7. In FIG. 7, components common to those of the first embodiment to the third embodiment are denoted by the same reference numerals, and detailed description thereof will be omitted. Note that FIG. 7 is a diagram corresponding to FIG. 2 in the printing device 1A according to the first embodiment. Here, the printing device 1D of the present embodiment has the same configuration as the printing device 1A of the first embodiment, except for the configurations of the display panel 300D and the accommodation section 310 for the display panel 300D. For this reason, the printing device 1D of the present embodiment has the same features as those of printing device 1A of the first embodiment, except for the portions described below.

As illustrated in FIGS. 2 and 3, in the printing device 1A according to the first embodiment, the display light 302A is provided on the pivoting end surface 309 of the display panel 300A. On the other hand, as illustrated in FIG. 7, in the printing device 1D of the present embodiment, display lights 302D are provided on a side surface 307 and on a side surface 308, which are side surfaces in a direction intersecting the display screen 305 and the back surface 306. Since the printing device 1D of the present embodiment has such a configuration, when the display panel 300D is exposed, the display lights 302D provided on the display panel 300D can be particularly easily seen from the back surface 306 side (the third direction side, which is the side of the display panel 300D substantially opposite from the display screen 305 and which is the back surface side of the printing device 1D). Further, it is possible to facilitate checking from the side surface 307 side and the side surface 308 side of the display panel 300D, that is, the side surface sides of the printing device 1D.

It should be noted that in the printing device 1D of the present embodiment, the display lights 302D are configured to be immovable with respect to the side surface 307 and the side surface 308, but is not limited to such a configuration. For example, the display lights 302D may have a configuration such as that of the display light 302B of printing device 1B according to the second embodiment, and the display lights 302D provided on the side surface 307 and on the side surface 308 may protrude along the X-axis direction with respect to the display panel 300D in conjunction with the display panel 300D being pivoted from the stored position to the exposed position. The display lights 302D of the present embodiment have the same configuration as the display light 302A of the printing device 1A of the first embodiment, except for the arrangement with respect to the display panel 300D.

### FIFTH EMBODIMENT

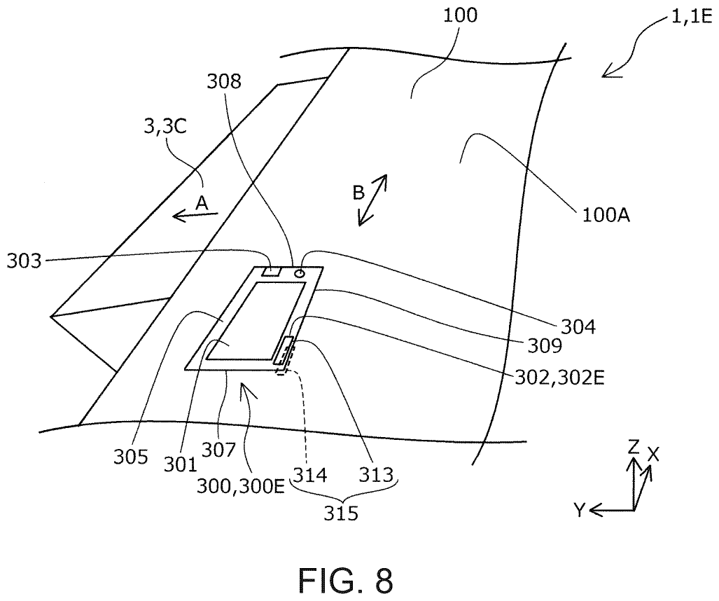

Next, a printing device 1E according to a fifth embodiment will be described with reference to FIG. 8. In FIG. 8, components common to those of the first embodiment to the fourth embodiment are denoted by the same reference numerals, and detailed description thereof will be omitted. FIG. 8 is a diagram corresponding to FIG. 2 in the printing device 1A according to the first embodiment. The printing device 1E according to the present embodiment has the same configuration as the printing device 1A according to the first embodiment, except for the configurations of the display panel 300E and the accommodation section 310 for the display panel 300E. For this reason, the printing device 1E of the present embodiment has the same features as those of printing device 1A of the first embodiment, except for the portions described below.

As illustrated in FIGS. 2 and 3, in the printing device 1A according to the first embodiment, the display light 302A is a protruding section provided on the pivoting end surface 309 of the display panel 300A. On the other hand, as shown in FIG. 8, in the printing device 1E of the present embodiment, the display light 302E is not a protruding section provided on the display panel 300E.

To be specific, in the display light 302E of the present embodiment, a transparent window 313 is provided on the display screen 305, a transparent window 314 is provided on the back surface 306, and LEDs are provided in an inner region of the display panel 300E facing the transparent window 314 and the transparent window 313. In other words, the display light 302E of the present embodiment is provided so as to be visible through the transparent window 314 from the back surface 306 side, which is the opposite side from the display screen 305, and the back surface 306 has a translucent section 315 through which light is transmitted toward the side opposite from the back surface 306. Since the printing device 1E of the present embodiment has such a configuration, when the display panel 300E is exposed, various types of information displayed on the display screen 305 can be confirmed from the back surface 306 side, that is, from the third direction (−Y direction), which is substantially opposite from the display screen 305 of the display panel 300E and which is the back surface side of the printing device 1E.

In the printing device 1E of the present embodiment, the display light 302E has the translucent section 315 on the display screen 305 in addition to on the back surface 306, but is not limited to such a configuration. The translucent section 315 may be provided only on the back surface 306, or the translucent section 315 may be provided on at least one of the display screen 305, the side surface 307, and the side surface 308.

### SIXTH EMBODIMENT

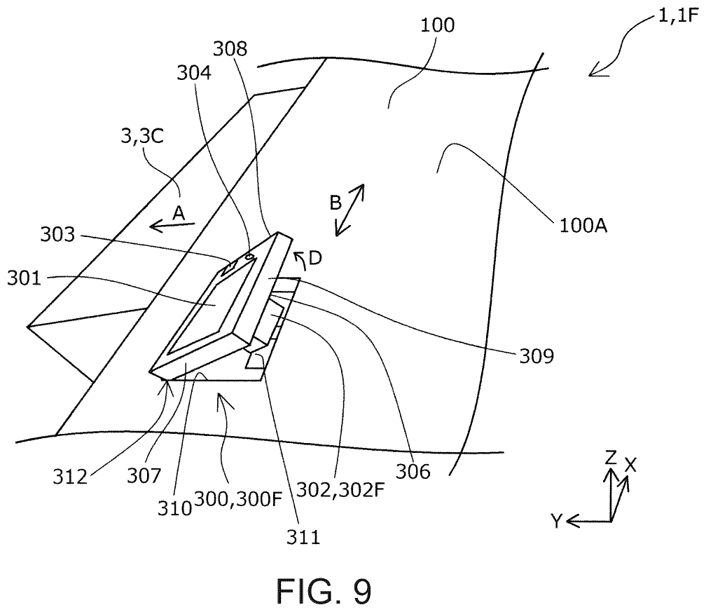

Next, a printing device 1F according to a sixth embodiment will be described with reference to FIG. 9. In FIG. 9, components common to those of the first embodiment to the fifth embodiment are denoted by the same reference numerals, and detailed description thereof will be omitted. FIG. 9 is a diagram corresponding to FIG. 3 in the printing device 1A according to the first embodiment. The printing device 1F according to the present embodiment has the same configuration as the printing device 1A according to the first embodiment, except for the configurations of the display panel 300F and the accommodation section 310 for the display panel 300F. For this reason, the printing device 1F of the present embodiment has the same features as those of the printing device 1A of the first embodiment, except for the portions described below.

As illustrated in FIGS. 2 and 3, in the printing device 1A according to the first embodiment, the display light 302A is a protruding section provided on the pivoting end surface 309 of the display panel 300A. On the other hand, as illustrated in FIG. 9, in the printing device 1F of the present embodiment, the display light 302F is a protruding section that in the exposed position protrudes from the back surface 306. In this way, by adopting a configuration in which the display light 302F protrudes from the back surface 306 in the exposed position, it is possible to make it particularly easy to, when the display panel 300F is exposed, see the display light 302F provided on the display panel 300F from the back surface 306 side (from the third direction side of the display panel 300F, which is substantially opposite from the display screen 305 and which is the back surface side of the printing device 1F). Further, it is possible to make it easy to see from the side surface 307 side and the side surface 308 side of the display panel 300F, that is, from the side surface sides of the printing device 1F. The accommodation section 310 is provided with a recess section 311 corresponding to the display light 302F, which protrudes from the back surface 306. The display light 302F, which protrudes from the display panel 300F, is accommodated in the recess section 311.

Note that in the printing device 1F of the present embodiment, the display light 302F is configured to be immovable with respect to the back surface 306, but is not limited to such a configuration. For example, the display light 302F may have a configuration such as that of the display light 302B of the printing device 1B according to the second embodiment, and the display light 302F provided on the back surface 306 may protrude out from the back surface 306 in conjunction with the display panel 300F being pivoted from the stored position to the exposed position. By a configuration in which the display light 302F does not protrude from the back surface 306 in the stored position, it is not necessary to provide the recess section 311 in the accommodation section 310, and the storage volume of the display panel 300F can be reduced. The display light 302F of the present embodiment has the same configuration as the display light 302A of the printing device 1A of the first embodiment, except for the arrangement with respect to the display panel 300F.

The present disclosure is not limited to the above-described embodiments, and can be realized by various configurations without departing from the scope of the present disclosure. The technical features in the embodiments corresponding to the technical features in the aspects described in the summary of the disclosure can be replaced or combined as appropriate in order to solve some or all of the problems described above or in order to achieve some or all of the effects described above. If the technical feature is not described as essential in the present specification, the technical feature can be appropriately deleted.

What is claimed is:

1. A printing device comprising:
a printing section configured to print on a medium;
a housing that covers at least a first direction of the printing section; and
a display panel configured to be displaced to a stored position in which a display screen faces a first direction and is stored in the housing and to an exposed position in which the display panel is exposed from the housing to outside so that the display screen is visible when viewed from a second direction that intersects the first direction, wherein
the display panel includes a display light that, in the exposed position, is visible when viewed from a third direction that is opposite to the second direction and
an illumination state of the display light is variable.

2. The printing device according to claim 1, wherein
the display light is provided at a position which, in the exposed position, is an end section of the display panel in the first direction when viewed from the second direction.

3. The printing device according to claim 2, wherein
the display light is provided on a protruding section that, in the exposed position, protrudes in the first direction when viewed from the second direction.

4. The printing device according to claim 3, wherein
the protruding section is stored in the display panel in the stored position and, in conjunction with displacement from the stored position to the exposed position, protrudes in the first direction when viewed from the second direction.

5. The printing device according to claim 2, wherein
the display light is provided across an entire widthwise direction in a position that, in the exposed position, is an end section of the display panel in the first direction when viewed from the second direction.

6. The printing device according to claim 1, wherein
the display light is provided so as to be visible from a side facing a back surface, which is opposite from the display screen.

7. The printing device according to claim 6, wherein
the display light protrudes from the back surface in the exposed position.

8. The printing device according to claim 6, wherein
the display light is provided on a side surface in a direction that intersects the display screen and the back surface.

9. The printing device according to claim 6, wherein
the display light is provided so as to be visible from a side facing the display screen and
the back surface has a translucent section through which light is transmitted toward a side facing the back surface.
